(19) United States
(12) Patent Application Publication
(10) Pub. No.: US 2007/0247866 A1
(43) Pub. Date: Oct. 25, 2007

(54) Casing and installation-ready assembly for a motorcycle, corresponding motorcycle and its method of manufacture

(75) Inventor: Joel Leon Robert Domergue, Aniane (FR)

Correspondence Address: Ralph A. Dowell of DOWELL & DOWELL P.C., 2111 Eisenhower Ave, Suite 406, Alexandria, VA, 22314, US

(73) Assignee: ENGINEERING AND MORE, Aniane (FR)

(21) Appl. No.: 11/790,219

(22) Filed: Apr. 24, 2007

(30) Foreign Application Priority Data
Apr. 24, 2006 (FR) 06 03619

(51) Int. Cl. B60Q 1/00

(52) U.S. Cl. 362/547

(57) ABSTRACT

This casing (1) comprises a hollow body in which various housings are arranged suitable for receiving items of equipment of the motorcycle, in particular a front headlight insert (38) and/or a display (42) and/or turn signal lamps (44), first means (28) for attaching the hollow body (2) to a first location of the motorcycle front fork, and second means (30, 34, 36) for attaching the hollow body to a second location of the motorcycle front fork.

The present invention relates to an installation-ready assembly for a motorcycle front fork, an installation-ready assembly comprising such a casing, a motorcycle fitted with such an assembly, and a method of manufacturing such a motorcycle.

In a conventional manner, a motorcycle comprises a chassis mounted on wheels, with which are mainly associated an engine, a seat and a steering assembly. The aforementioned chassis consists amongst other things of a front fork, which comprises two vertical tubes, from which the motorcycle handlebars extend.

The latter is also furnished, in its front portion, with various items of equipment, particularly of the electrical type, that have to be fitted onto the chassis. Such items of equipment are in particular a front headlight insert, a display performing in particular a tachymeter function, and turn signal lamps. These various items of equipment are associated with electrical conductors that have to be connected to the central energy source of the vehicle.

Conventionally, the aforementioned items of equipment are fitted onto the front fork in a separate manner, by means of several attachment members, such as plates. The latter, that are themselves fixedly attached to the vertical tubes of the fork, provide for the installation of these various items of equipment.

This known solution however has certain disadvantages. Specifically, the installation of the aforementioned items of equipment on the motorcycle front fork takes a relatively long time to perform, while being accompanied by a certain complexity.

This being specified, the object of the invention is to remedy the various disadvantages of the prior art mentioned above. Its particular objective is to propose an arrangement allowing easy and fast installation and removal of the various items of equipment mentioned above, on the motorcycle front fork.

For this reason, its subject is a casing of an installation-ready assembly for a motorcycle front fork, this casing comprising a hollow body in which various housings are arranged suitable for receiving items of equipment, particularly electrical items, of said motorcycle, in particular a front headlight insert and/or a display and/or turn signal lamps, this casing also comprising means for attaching the hollow body to the motorcycle front fork.

According to other features of the invention:
the hollow body is made in a single piece, being made in particular of a plastic such as polyethylene;
the means for attaching the hollow body are suitable for conferring a damping character on the attachment of this hollow body relative to the motorcycle front fork;
this casing comprises first means for attaching the hollow body to a first location of the motorcycle front fork, and second means for attaching the hollow body to a second location of the motorcycle front fork;
the first attachment means comprise at least one damper packing piece, made of a flexible material, that is capable of being wedged on at least one reception pad formed on the top face of the hollow body;
the second attachment means comprise a screw, extending through a bottom lug of the hollow body, a locknut mounted on this screw, and a spring interposed between this locknut and the wall facing said lug.

A further subject of the invention is an installation-ready assembly for a motorcycle front fork, comprising a casing as defined above, and various items of equipment, particularly electrical items, of said motorcycle, in particular a front headlight insert and/or a display and/or turn signal lamps, each of said items of equipment being received in a corresponding reception housing made in the hollow body of the casing.

According to another feature of the invention, each item of equipment is provided with a conducting member, while a relay is provided for connecting said conducting members, this relay being provided with an output conducting member, extending outside the hollow body.

A further subject of the invention is a motorcycle comprising a fork, and an installation-ready assembly as defined above that is installed on the front fork.

According to other features of the invention:
the front fork comprises a top cross member provided with two posts, and each post interacts with an annular portion of a corresponding damper packing piece;
the front fork comprises a bottom cross member in which a tapping is made, said screw being screwed into said tapping.

Finally the subject of the invention is a method of manufacturing the motorcycle as defined above, wherein each item of equipment is placed in a corresponding housing, so as to form said installation-ready assembly, and said assembly is installed on the motorcycle front fork.

The invention will be described below with reference to the appended drawings given purely as a nonlimiting example, wherein:

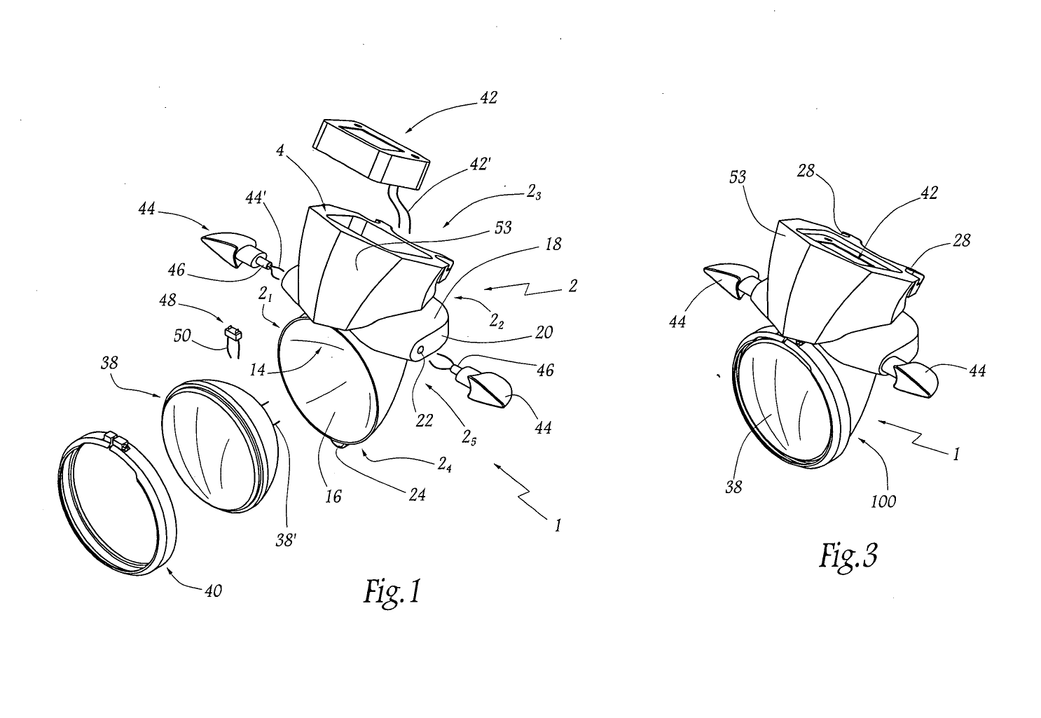

FIG. 1 is an exploded view in perspective illustrating a casing according to the invention, and accessories associated therewith;

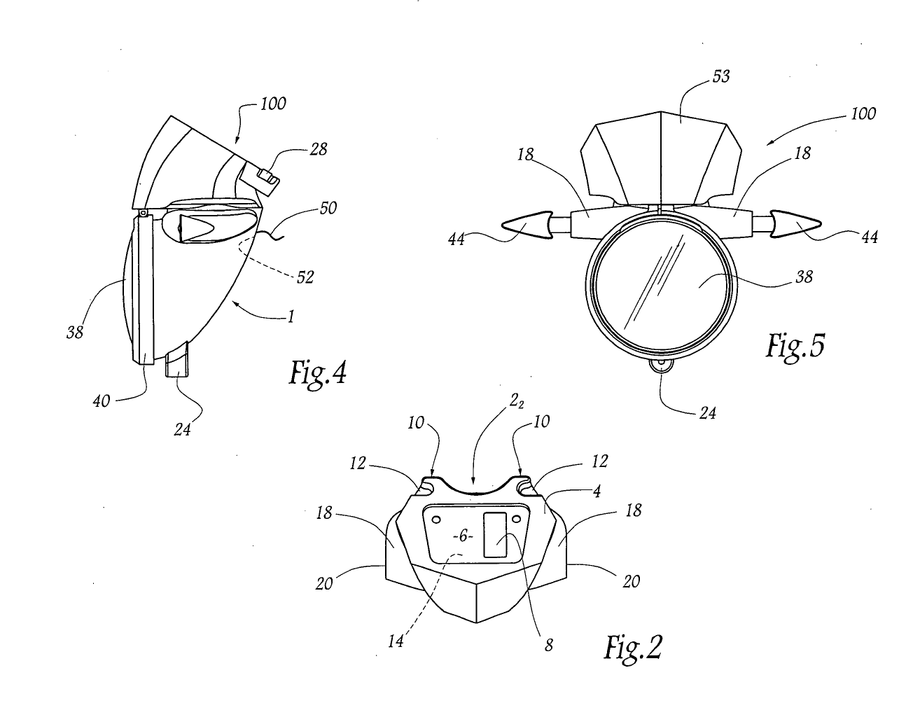

FIG. 2 is a top view illustrating the casing of FIG. 1;

FIGS. 3 to 5 are views respectively in perspective, from the side and from the front, illustrating an installation-ready assembly according to the invention; and

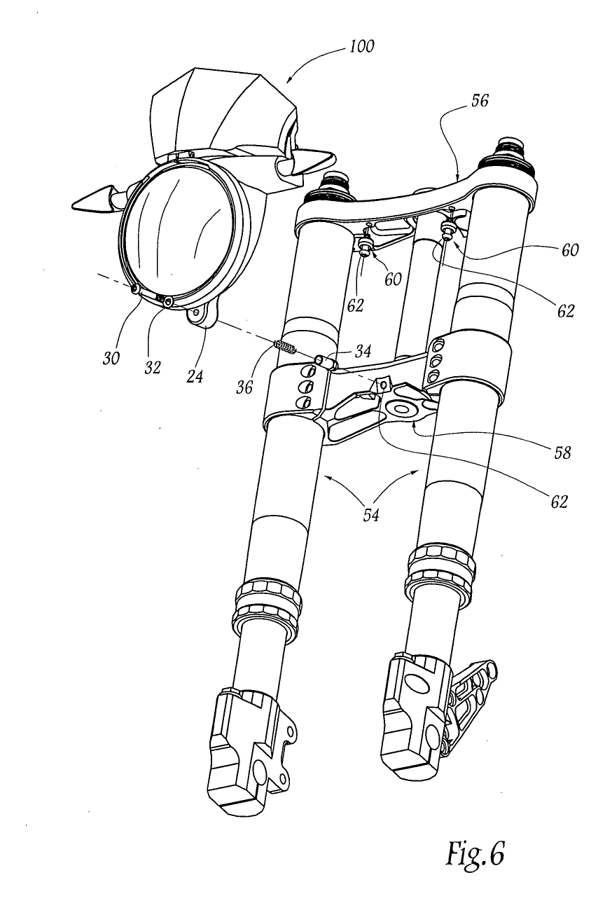

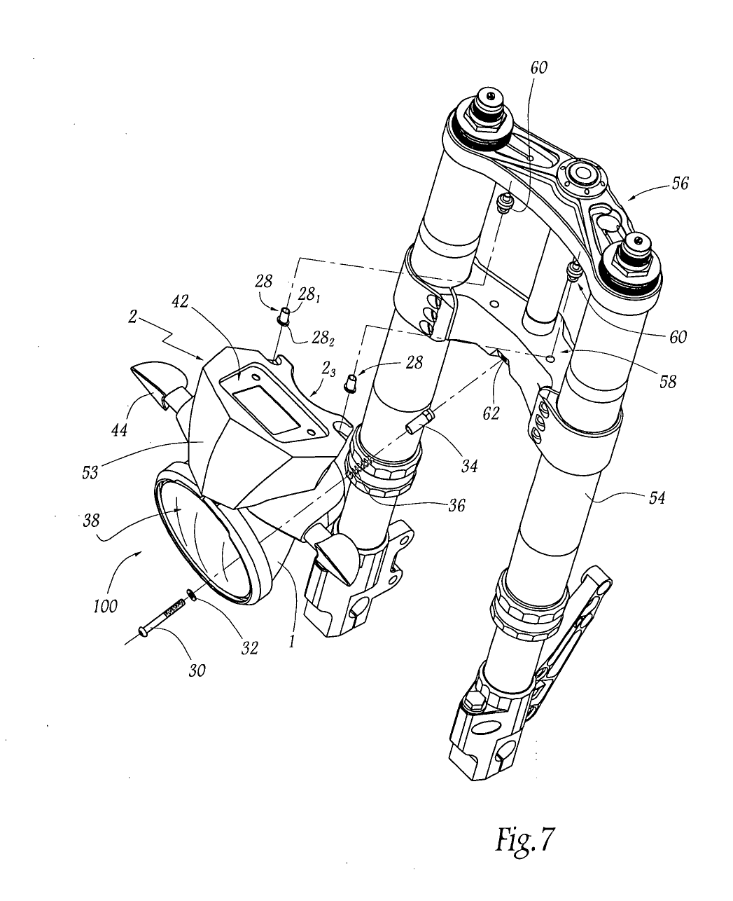

FIGS. 6 and 7 are views in perspective illustrating, from two different angles, the installation of this assembly on a motorcycle.

The casing according to the invention, illustrated in particular in FIGS. 1 and 2, is indicated in its entirety by reference number 1. It consists essentially of a hollow body 2, made in a single piece, advantageously by molding of a plastic, such as polyethylene.

With reference to its position once installed on the motorcycle, the various faces of this hollow body 2 are given the following reference numbers: front face 2₁, rear face 2₂, top face 2₃, bottom face 2₄ and lateral faces 2₅. Seen from the front, the casing 1 has an almost triangular shape.

The top face 2₃ of the hollow body 2 defines a peripheral border 4, with a central recess cut out of it that delimits a first housing 6, designed to receive a display as will be seen in the following. An opening 8 is also made in the bottom wall of this housing so as to allow conductor elements associated with the aforementioned display to pass through.

The border 4 is extended toward the rear face 2₂ by two lateral hooks 10 that define two pads 12 for receiving damper packing pieces, as will be seen below. Therefore, each pad 12 is bordered, at its internal lateral side, by the walls of the hooks 10, that have a substantially semicircular shape seen from above, in order to perform an abutment function. On the other hand, opposite these walls, namely in an external lateral direction, the pads 12 are open.

The aforementioned opening 8 opens into a main housing 14, made inside the hollow body 2 forming the casing 1. The front face 2₁ also has a substantially circular orifice 16 cut out of it, that also opens into the main housing 14. This orifice 16 is designed to receive a headlight insert as will be seen below.

The two lateral faces 2₅ define protrusions 18, that are truncated by end flats 20, extending vertically when the casing is placed on the motorcycle. Each flat 20 has a hole 22 cut out of it, allowing the coupling of a turn signal lamp as will be seen below. Finally, at its bottom face 2₄, the hollow body 2 is provided with a hollow lug 24, whose front and rear walls respectively have orifices 6 cut out of them, extending opposite one another.

The casing 1 is associated with various elements making it possible to attach it to the chassis of the motorcycle. These attachment elements comprise first of all two packing pieces 28, made of a damping material, such as an elastomer. As shown in FIG. 7, each packing piece 28 comprises an annular rod 28₁, extended by a cylindrical head 28₂, of greater transverse dimension. It will be noted that the diameter of this head is close to that of the semicircular walls bordering the pads 12 made on the front face 2₁ of the casing.

Still referring to FIG. 7, the aforementioned attachment elements also comprise a screw 30 whose head is suitable for interacting with a washer 32. In addition, a locknut 34 is capable of being screwed onto the body of this screw 30, with interposition of a spring 36.

Various items of electrical equipment may be received in the casing 1, so as to form an installation-ready assembly according to the invention. This involves first of all a front headlight insert 38, of a type known per se. This insert is suitable for being inserted into the orifice 16, while being fixed relative to the walls of this orifice thanks to a clamping collar 40 of a conventional type.

In addition, a display 42, combining in particular the functions of tachymeter and revolution counter, may be received in the top housing 6. Two turn signal lamps 44 may be inserted, by means of pins 46, into the lateral holes 22 of the casing 1. Finally, the front face 2₁ of the hollow body 2 may also be covered, at least partially, with a decorative element 53, represented schematically.

The headlight 38, the display 42 and the turn signal lamps 44 are associated with conductor members, represented schematically and assigned respective reference numbers 38′, 42′ and 44′. These various conductor members are suitable for being connected to a relay 48, also represented schematically. This relay 48 is itself fitted with an output conductor member 50 which extends in service outside the casing, through a hole 52 made in the rear face of the latter (FIG. 4).

The casing 1, and these various items of electrical equipment 38, 42 and 44 may be installed on a motorcycle front fork, represented partially in FIGS. 6 and 7. The figures show two vertical tubes 54 that are connected in a conventional manner by two cross members, respectively a top cross member 56 and a bottom cross member 58.

The top cross member 56 receives two screws 60 placed on either side of a longitudinal median axis of the motorcycle. In this manner, the head 62 of these screws protrudes downward relative to the body of this cross member, so as to interact with the packing pieces 28 as will be seen below.

In addition, the bottom cross member 58 has, on its front face, a tapping 62 made in it. The latter is arranged obliquely, to the effect that, from front to rear of the motorcycle, it extends from bottom to top.

The assembling of the installation-ready assembly according to the invention and its installation on the motorcycle front fork will now be described below.

It first of all involves inserting the various items of electrical equipment into their corresponding housing made in the casing 1. Therefore, the headlight insert 38 is fixed relative to the walls of the orifice 16 thanks to the collar 40. The display 42 is also placed in the top housing 6.

Finally, each pin 46 of a respective turn signal lamp 44 is inserted into a corresponding hole 22. The various conductor members 38′, 42′ and 44′ are also connected to the relay 48, by pulling out the output conductor member 50 of the latter through the hole 52.

In addition, each packing piece 28 is placed on its corresponding reception pad 12. Accordingly, each head 28₂ is wedged against the walls of the hooks 10, while each rod 28₁, protrudes upward. As a variant, it is possible to provide a single packing piece which, by its shape and/or its dimensions, provides an isostatic character to the attachment of the casing.

Finally, the screw 30 is inserted through the orifices 26 of the bottom lug 24, by placing the head of this screw 30 against the front face of this lug, with interposition of the washer 32. In addition, the locknut 34 is placed on this screw 30, the spring 36 being interposed between the latter and the rear face of the lug 24.

Once these operations are complete, the user has an installation-ready assembly. The latter, that is given the reference number 100 in FIGS. 3 to 7, is capable of being fixedly attached to the motorcycle front fork.

Accordingly, the top face 2₃ of the hollow body 2 is placed in the vicinity of the top cross member 56, slightly below the latter. Then, the casing 1 is raised so that the annular rod 28₁, of each packing piece 28 comes to cover the head of the screws 60 protruding downward from this top cross member 56. The assembly 100 is then held relative to the front fork at its top end.

It is then tilted toward the back of the motorcycle until the end of the screw 30 comes close to the tapping 62 made in the bottom cross member 58. It is then a question of screwing this screw 30 into this tapping 62 so as to fix the installation-ready assembly relative to the fork. The electrical output 50 is finally connected to a central source of energy of the motorcycle, such as a battery.

It will be noted that, depending on the amount by which the screw 30 is screwed into the tapping 62, the headlight insert 38 is more or less inclined relative to a horizontal direction. It can be seen therefore that the position of this insert may be adjusted very simply using a simple manipulation of this screw 30. Finally, this headlight insert may be held in position reliably by screwing the locknut 34 against the wall opposite the bottom cross member 58.

During the use of the motorcycle, the various attachment elements, namely in particular the packing pieces 28 and the screw 30, allow a secure retention of the assembly 100 relative to the fork. Furthermore, these attachment elements perform an additional damping function, in particular with regard to the vibrations sustained by the motorcycle. This damping character is conferred by the flexible nature of the packing pieces 28 on the one hand and by the presence of the spring 36 on the other hand.

The invention makes it possible to achieve the aforementioned objectives.

Specifically, it provides for particularly fast and simple installation of the various items of equipment capable of being associated with the front fork of a motorcycle. Therefore, according to the invention, the casing may be provided in advance with the aforementioned various items of equipment, then installed in a single operation on the motorcycle.

It will be noted that this speed relates not only to the installation but also the removal of this assembly. It can be seen therefore that, thanks to the invention, the manufacture but also the maintenance of the motorcycle are notably simpler than in the prior art.

It will also be noted that the compact form of the casing makes it possible to arrange, between the latter and the top portions of the fork rods, air passageways supplying the engine with combustion air.

1. A casing of an installation-ready assembly for a motorcycle front fork, this casing comprising a hollow body in which various housings are arranged suitable for receiving items of equipment, particularly electrical items, of said motorcycle, in particular a front headlight insert and/or a display and/or turn signal lamps, this casing also comprising means for attaching the hollow body to the motorcycle front fork.

2. The casing as claimed in claim 1, wherein the hollow body is made in a single piece, being made in particular of a plastic such as polyethylene.

3. The casing as claimed in claim 1, wherein the means for attaching the hollow body are suitable for conferring a damping character on the attachment of this hollow body relative to the motorcycle front fork.

4. The casing as claimed in claim 1, wherein this casing comprises first means for attaching the hollow body to a first location of the motorcycle front fork, and second means for attaching the hollow body to a second location of the motorcycle front fork.

5. The casing as claimed in claim 3, wherein the first attachment means comprise at least one damper packing piece, made of a flexible material, that is capable of being wedged on at least one reception pad formed on the top face of the hollow body.

6. The casing as claimed in claim 3, wherein the second attachment means comprise a screw, extending through a bottom lug of the hollow body, a locknut mounted on this screw, and a spring interposed between this locknut and the wall facing said lug.

7. An installation-ready assembly for a motorcycle front fork, comprising a casing as claimed in claim 1, and various items of equipment, particularly electrical items, of said motorcycle, in particular a front headlight insert and/or a display and/or turn signal lamps, each of said items of equipment being received in a corresponding reception housing made in the hollow body of the casing.

8. The assembly as claimed in claim 7, wherein each item of equipment is provided with a conducting member, while a relay is provided for connecting said conducting members, this relay being provided with an output conducting member, extending outside the hollow body.

9. A motorcycle including a chassis comprising a fork, and an installation-ready assembly as claimed in claim 7, this assembly being installed on said front fork.

10. The motorcycle as claimed in claim 9, wherein the means for attaching the hollow body are suitable for conferring a damping character on the attachment of this hollow body relative to the motorcycle front fork, the first attachment means comprise at least one damper packing piece, made of a flexible material, that is capable of being wedged on at least one reception pad formed on the top face of the hollow body wherein said front fork comprises a top cross member provided with two posts, and each post interacts with an annular portion of a corresponding damper packing piece.

11. The motorcycle as claimed in claim 9, wherein the means for attaching the hollow body are suitable for conferring a damping character on the attachment of this hollow body relative to the motorcycle front fork, the second attachment means comprise a screw, extending through a bottom lug of the hollow body, a locknut mounted on this screw, and a spring interposed between this locknut and the wall facing said lug wherein said front fork comprises a bottom cross member in which a tapping is made, said screw being screwed into said tapping.

12. A method of manufacturing the motorcycle as claimed in claim 9, wherein each item of equipment is placed in a corresponding housing, so as to form said installation-ready assembly, and said assembly is installed on the motorcycle front fork.
